(19) United States
(12) Patent Application Publication
(10) Pub. No.: US 2013/0185275 A1
(43) Pub. Date: Jul. 18, 2013

(54) METHODS AND SYSTEMS FOR SEARCHING ENTRIES IN SMART DEVICES

(71) Applicant: Hendricks Investment Holdings, LLC, Silver Spring, MD (US)

(72) Inventor: Stephen I. Hasenei, Silver Spring, MD (US)

(73) Assignee: HENDRICKS INVESTMENT HOLDINGS, LLC, Silver Spring, MD (US)

(21) Appl. No.: 13/740,755

(22) Filed: Jan. 14, 2013

Related U.S. Application Data
(60) Provisional application No. 61/586,340, filed on Jan. 13, 2012.

(51) Int. Cl. G06F 17/30

(52) U.S. Cl. CPC G06F 17/30424
USPC 707/706

(57) ABSTRACT

Systems and methods for allowing a smart device user to perform searches for contacts stored on the contacts directory of the smart device on the basis of parameters other than first name, last name or company name. Such parameters may include, for example, an email address, a telephone number, an area code, a nickname, an address, a zip code, another identifier, or any combination of the above. The user may be able to find specific contacts on the basis of identifiers other than first name, last name and/or company name such as an email address, a telephone number, an area code, a nickname, an address, a zip code, another identifier, or any combination of the above parameters.

This application claims priority from U.S. provisional patent application No. 61/586,340, filed on Jan. 13, 2012, titled “Methods and Systems for Searching Entries in Smart Devices,” and is incorporated herein by reference in its entirety.

### BACKGROUND OF THE INVENTION

1. Field of Invention

Aspects of the present invention relate to methods and systems to improve searching contacts in the contacts directory of a smart device. More particularly, aspects of the present invention relate to methods and systems to improve contact searching in the directory of a smart telephone, such as an iPhone.

2. Description of Related Art

Some smart phones, which have directories that include a list of contact names, telephone numbers and other contact information, are only organized to allow a user to search by first name, last name or company name of a given contact. For example, Apple's Contacts application, typically provided on iPhones, only allows the user to search by first name, last name or company name.

Accordingly, if a user desires to perform a search on the basis of an email address, a telephone number, a nickname, or other identifier, the user is currently unable to do so. This inability to search contacts via other fields than the above-discussed fields of first name, last name or company name may present a significant drawback for users who have large contacts directories with a large number of contacts having similar first names, last names and/or company names.

### SUMMARY OF THE INVENTION

In light of the above described problems and unmet needs as well as others, aspects of the current invention provide systems and methods for allowing a smart device user to perform searches for contacts stored on the contacts directory of the smart device, such as a smart telephone directory, on the basis of parameters other than first name, last name or company name. According to various aspects, such parameters may include, for example, an email address, a telephone number, an area code, a nickname, an address, a zip code, another identifier, or any combination of the above. Accordingly, when the contacts directory of a user includes a large number of contacts, a portion of those contacts having same first names, last names and/or company names, the user may be able to find specific contacts on the basis of identifiers other than first name, last name and/or company name. According to various aspects, the other parameters used to identify different contacts and that may be searchable may include, for example, an email address, a telephone number, an area code, a nickname, an address, a zip code, another identifier, or any combination of the above parameters.

According to various aspects of the current invention, in order to allow a user to search the contacts directory via other identifiers than first name, last name or company name, one or more additional fields may be provided in the contacts directory of the user, each additional field being usable as the basis for a search of the contacts. For example, when a new contact is established and entered in the contacts directory of a smart device, additional fields, or contact identifiers, may be added during the capture of the new contact, and each new field may be stored when the contact is stored in the contacts directory of the user's device. For example, the additional fields may include an email address, a telephone number, a nickname, an address, a zip code, another identifier, or any combination of the above.

Additional advantages and novel features of these aspects of the invention will be set forth in part in the description that follows, and in part will become more apparent to those skilled in the art upon examination of the following or upon learning by practice thereof.

### BRIEF DESCRIPTION OF THE DRAWINGS

Various example aspects of the systems and methods will be described in detail, with reference to the following figures, wherein:

FIG. 1 is a flow chart illustrating a method of searching contacts in a contacts directory, according to various aspects of the current invention;

FIGS. 2A-2C are illustrations of display screens of a searching function on a device, according to various aspects of the current invention;

FIGS. 3A-3B are illustrations of display screens of a searching function on a device, according to various aspects of the current invention;

FIG. 4 presents an example system diagram of various hardware components and other features, for use in accordance with an aspect of the present invention; and

FIG. 5 is a block diagram of various example system components, in accordance with an aspect of the present invention.

### DETAILED DESCRIPTION

These and other features and advantages in accordance with aspects of this invention are described in, or are apparent from, the following detailed description of various example aspects.

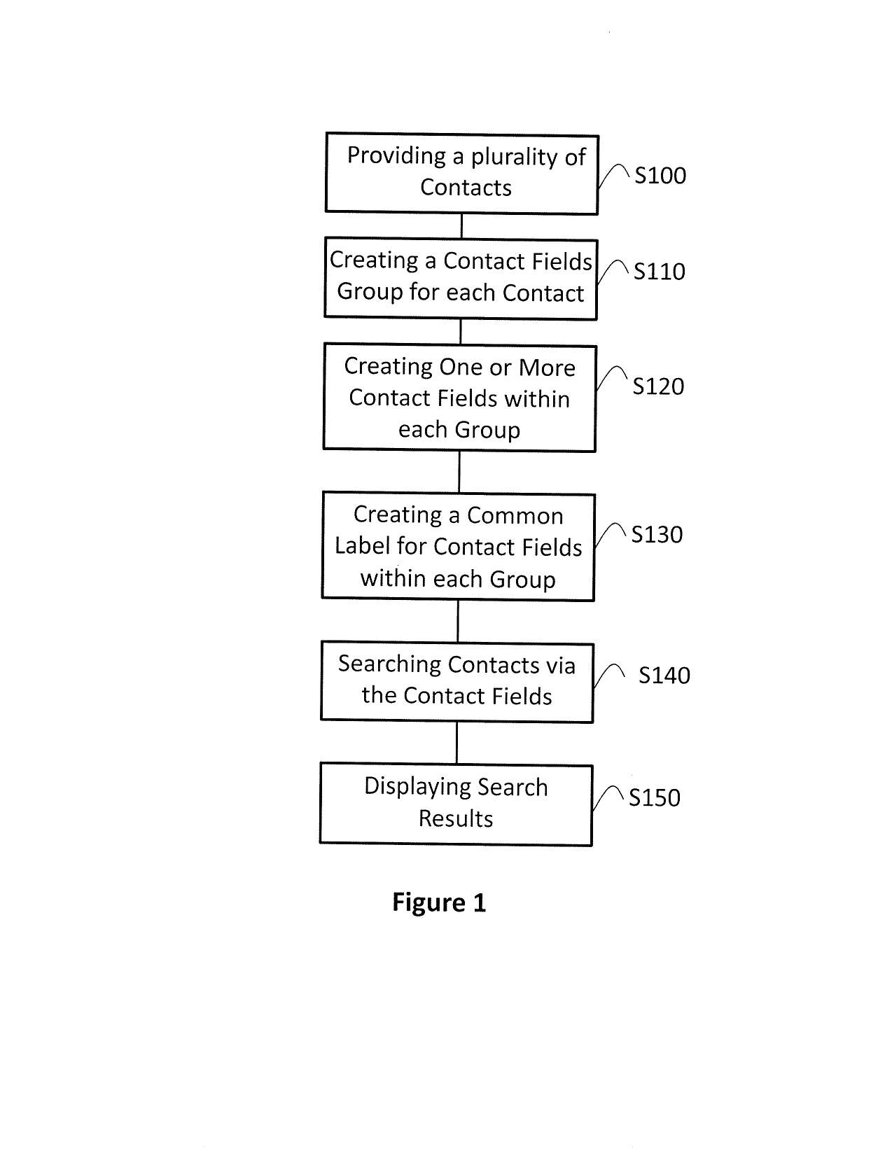

FIG. 1 is a flow chart illustrating a method of searching contacts in the contacts directory of a smart device, according to various aspects of the current invention. In FIG. 1 the method starts at S100, where contact information for a plurality of contacts are entered or provided in the contacts directory of a user's device. According to various aspects, the device may be a portable device, such as a cellular telephone, or any other suitable device, such as a smart device. When the new contacts are entered or otherwise provided in the contacts directory of the device, the method continues to S110, where a contact fields group is created for each contact. According to various aspects, the contact fields group may include a plurality of fields that are specific to each contact. In S120, one or more contact fields may be created within each group of fields, the one or more contact fields being related specifically to each contact, the groups of fields and the one or more contact fields being stored in an accessible data repository of the device, or in an accessible repository that is coupled to and accessible via the device. According to various aspects, the groups of fields and the contact fields within each group of fields may be related to, and dependent from, each contact. For example, the group of fields related to person A may include contact fields such as the first and/or last name of person A as well as the telephone number, address, area code, zip code, email address, nickname, or any other like identifier of person A.

According to various aspects, when a plurality of contact fields are entered by the user or otherwise provided for the same contact person or entity, the method continues to S130, where each one of the contact fields may be stored in a separate memory field, and each memory field corresponding to each of the contact fields within each group of fields and for the same contact person or entity may be provided with a label common to all the memory fields within a same group and thus corresponding to the same contact person or entity. Accordingly, all the contact fields for the same person or entity may have a same or similar label, and different persons or entities stored in the contacts directory may be assigned different labels differentiating each person or entity from another.

According to various aspects, when the one or more contact fields are created, stored and labeled, and are ready to be used via a search, the method continues to S140 where a user searches the contacts directory for a contact person or entity. According to various aspects, the contacts directory may have a search engine and the contact fields may be searchable contact fields, where one or more of the above-discussed fields may be used to retrieve the remaining contact information or identity of a person or entity corresponding to the contact fields. For example, a zip code may be entered in the search engine. As a result of entering the zip code in the search engine, all contacts that are stored in the contacts directory and that share that same zip code may be displayed on a display of the device as a result. Accordingly, in cases where a user's contacts directory includes a large number of contacts and a portion of these contacts have same first names, same last names and/or same company names, the user may be able to find specific contacts on the basis of identifiers other than first name, last name and/or company name, the other identifiers including, for example, an email address, a telephone number, a nickname, an address, an area code, a zip code, another identifier, or any combination of the above.

Accordingly, when a user enters part or all of a first name, a last name, a company name, an email address, a nickname, an address, an area code, a zip code, or any other like identifier, all the memory fields contained in each of the fields groups for all the contacts stored in the user's contacts directory may be searched via the search engine. According to various aspects, when one or more search terms correspond to one or more of the memory fields stored in the contacts directory, then a partial or full contact information, which may include the name, telephone number or address of any persons or entities corresponding to the one or more search terms are displayed to the user in S150.

According to various aspects, the contact information of the persons or entities corresponding to the one or more search terms is provided to the user by retrieving the remaining contact fields, such as name, telephone number or address, that are part of the same group of fields and that share a same label as the memory fields that correspond the one or more search terms. According to various aspects, the search engine may provide a plurality of contacts who share the same search terms, such as a zip code. In this case, the user may then choose which contact, among the displayed contacts, is the contact that is sought. For example, when a user enters a zip code as a search term in the contacts directory of the device, if more than one contact person or entity share the same zip code, then the names, telephone numbers and/or addresses of each of those persons or entities may be displayed to the user at S150.

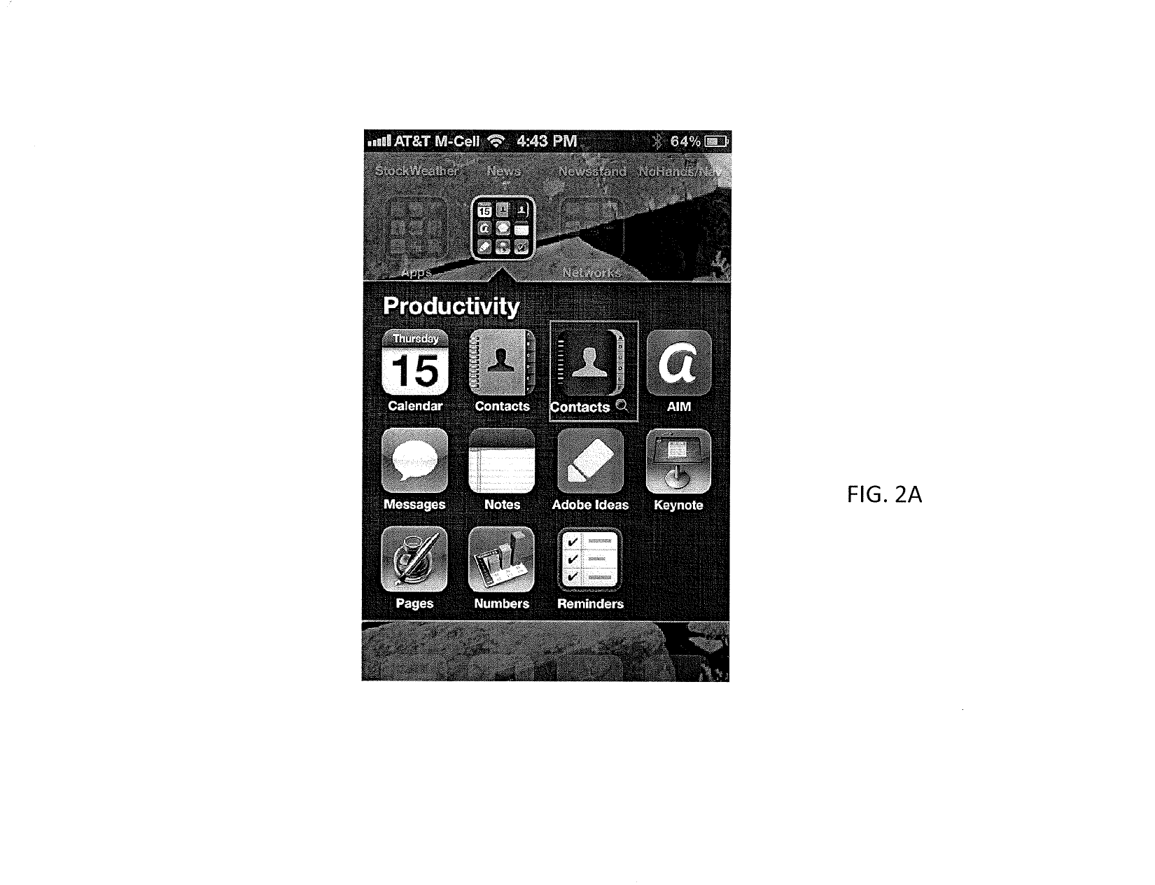

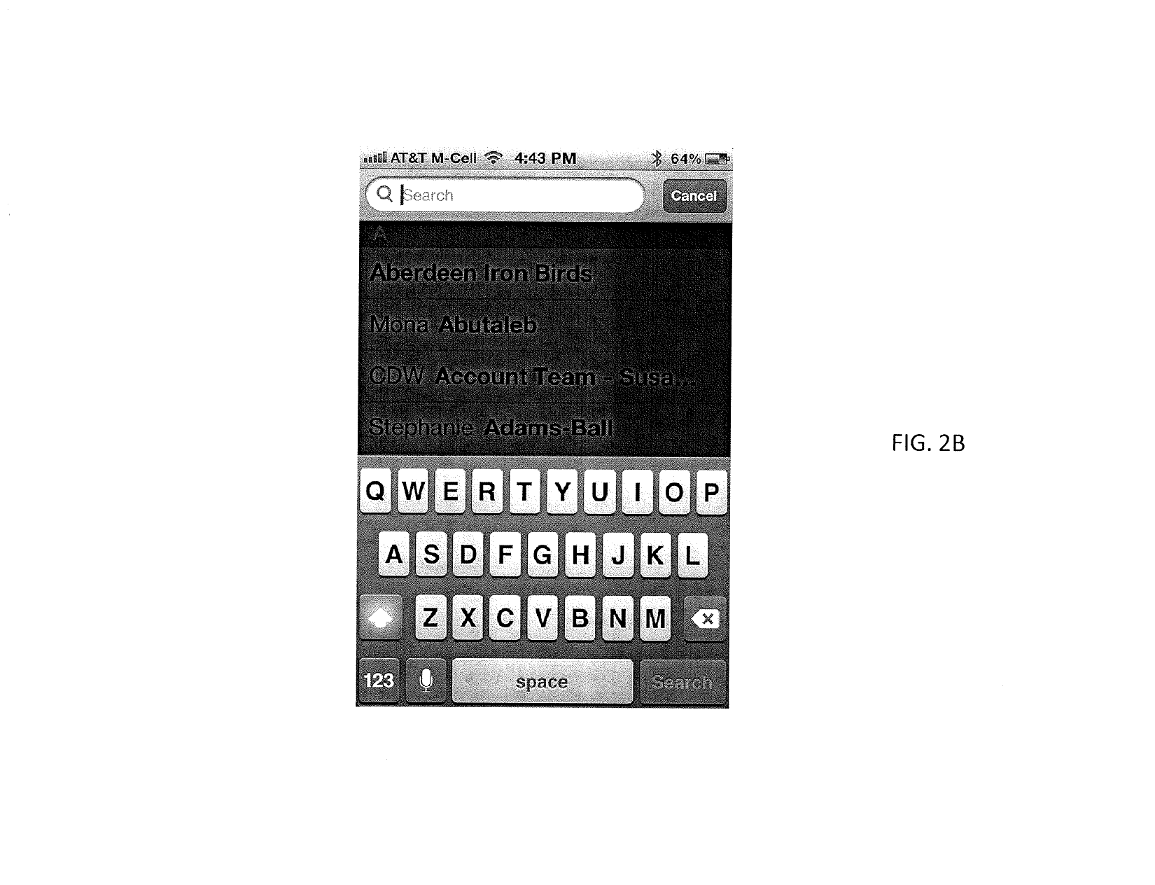

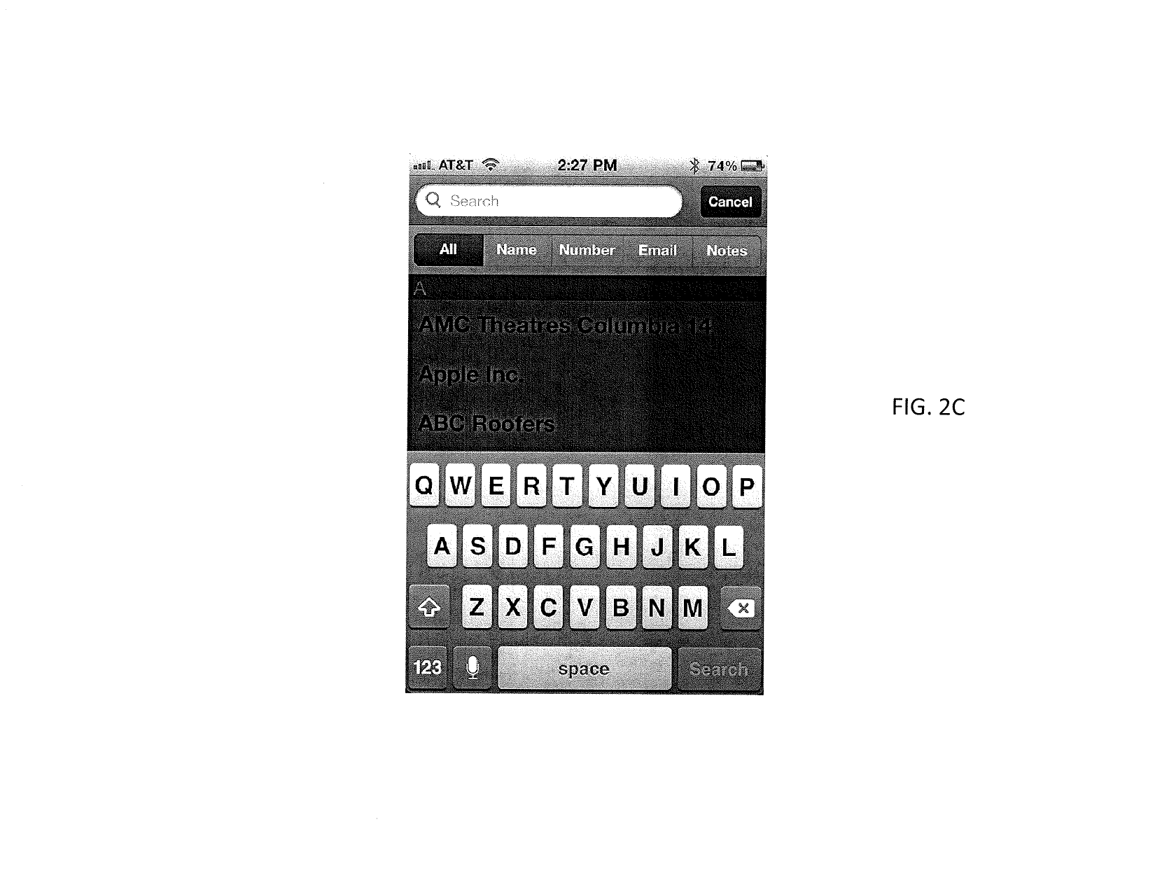

FIGS. 2A-C are illustrations of display screens of an example cellular telephone application and search screens, according to various aspects of the current invention. In FIG. 2A, a contact search icon is illustrated on a display screen of, for example, a smart telephone. In FIGS. 2B-2C, a search of contacts stored on the smart device is illustrated, where the contacts are searched on a basis other than first name, last name or company name.

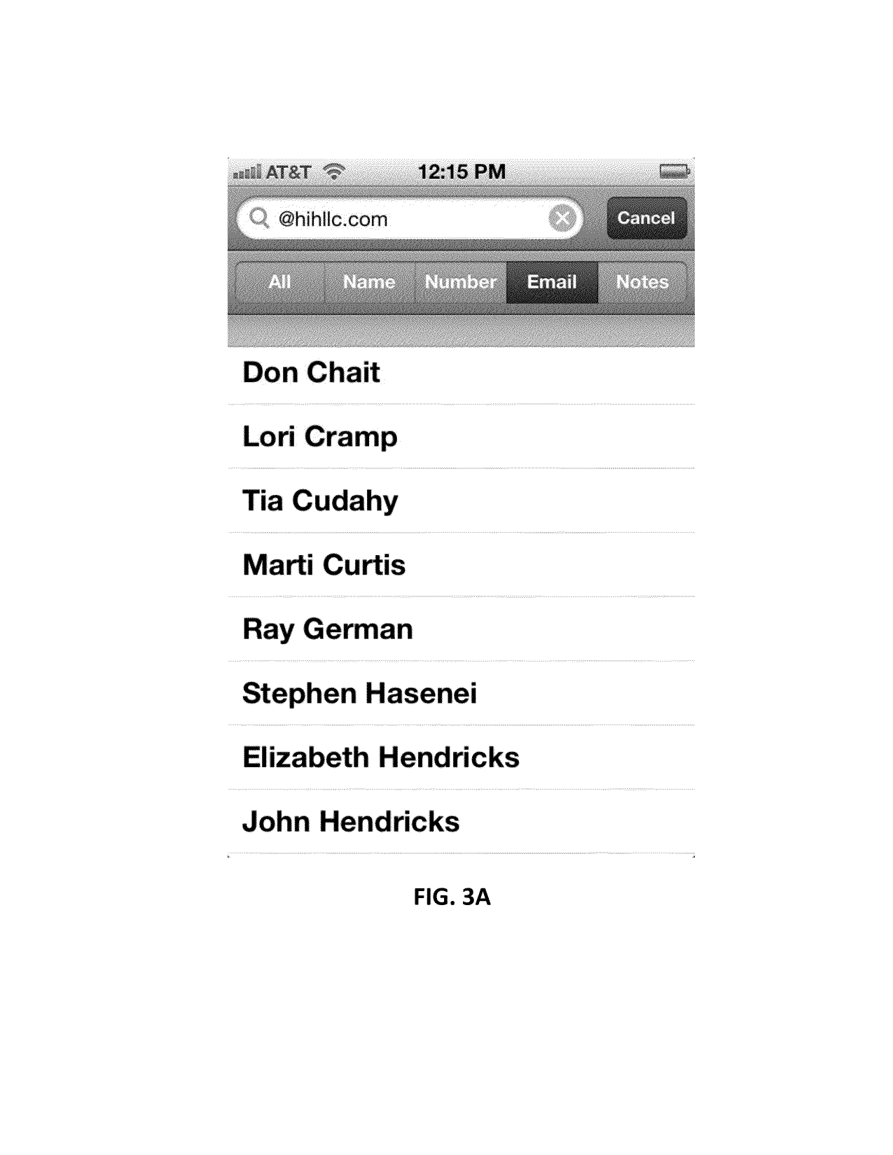

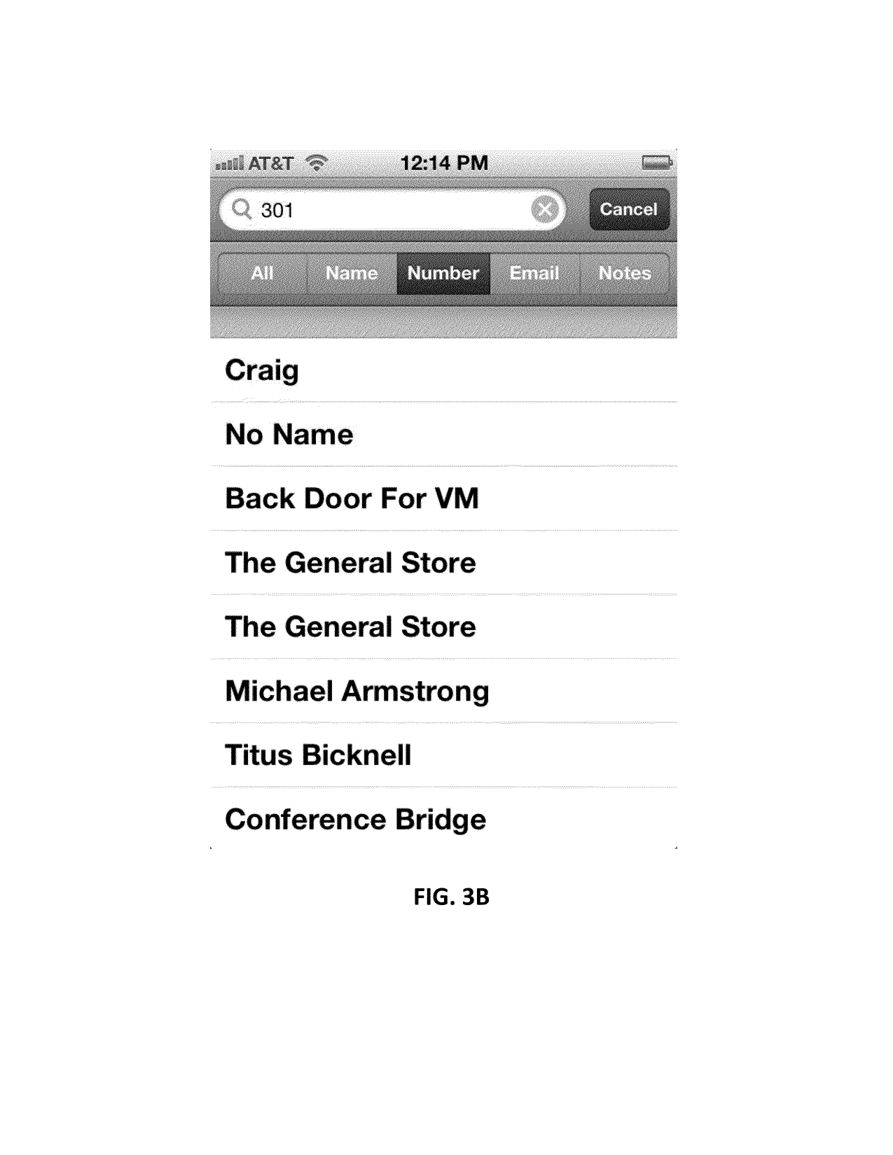

FIGS. 3A-3B are illustrations of example display screens of a searching function on a device, according to various aspects of the current invention. In FIG. 3A, a contact search icon is illustrated on a display screen of, for example, a smart telephone, where the search is based on an email address. In FIG. 3B, a search of contacts stored on a smart device is illustrated, where the search is based on an area code or a telephone number.

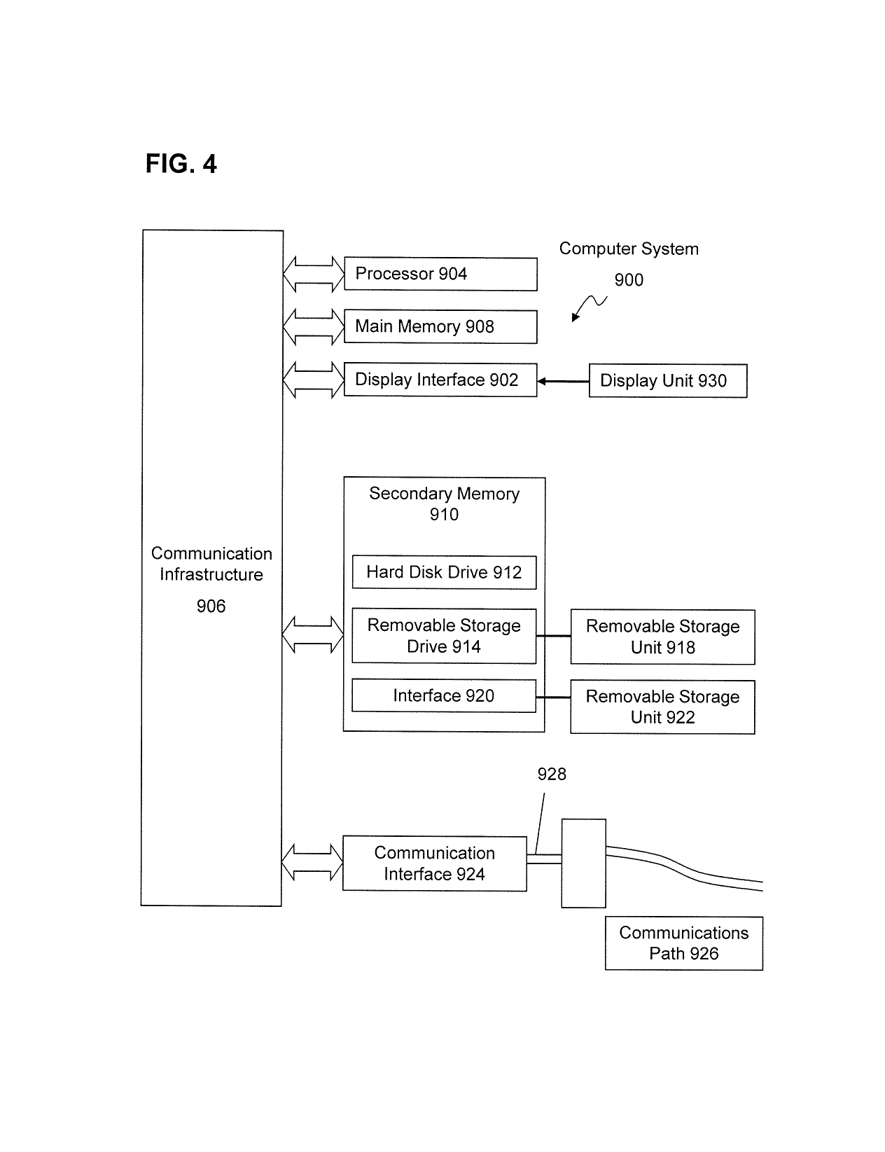

FIG. 4 presents an example system diagram of various hardware components and other features, for use in accordance with an aspect of the present invention. The present invention may be implemented using hardware, software, or a combination thereof and may be implemented in one or more computer systems or other processing systems. In one aspect, various features of the invention may be directed toward one or more computer systems capable of carrying out the functionality described herein. An example of such a computer system 900 is shown in FIG. 4.

Computer system 900 includes one or more processors, such as processor 904. The processor 904 is connected to a communication infrastructure 906 (e.g., a communications bus, cross-over bar, or network). Various software aspects are described in terms of this example computer system. After reading this description, it will become apparent to a person skilled in the relevant art(s) how to implement the invention using other computer systems and/or architectures.

Computer system 900 can include a display interface 902 that forwards graphics, text, and other data from the communication infrastructure 906 (or from a frame buffer not shown) for display on a display unit 930. Computer system 900 also includes a main memory 908, preferably random access memory (RAM), and may also include a secondary memory 910. The secondary memory 910 may include, for example, a hard disk drive 912 and/or a removable storage drive 914, representing a floppy disk drive, a magnetic tape drive, an optical disk drive, etc. The removable storage drive 914 reads from and/or writes to a removable storage unit 918 in a well-known manner. Removable storage unit 918, represents a floppy disk, magnetic tape, optical disk, etc., which is read by and written to removable storage drive 914. As will be appreciated, the removable storage unit 918 includes a computer usable storage medium having stored therein computer software and/or data. In alternative aspects, secondary memory 910 may include other similar devices for allowing computer programs or other instructions to be loaded into computer system 900. Such devices may include, for example, a removable storage unit 922 and an interface 920. Examples of such may include a program cartridge and cartridge interface (such as that found in video game devices), a removable memory chip (such as an erasable programmable read only memory (EPROM), or programmable read only memory (PROM)) and associated socket, and other removable storage units 922 and interfaces 920, which allow software and data to be transferred from the removable storage unit 922 to computer system 900.

Computer system 900 may also include a communications interface 924. Communications interface 924 allows software and data to be transferred between computer system 900 and external devices. Examples of communications interface 924 may include a modem, a network interface (such as an Ethernet card), a communications port, a Personal Computer Memory Card International Association (PCMCIA) slot and card, etc. Software and data transferred via communications interface 924 are in the form of signals 928, which may be electronic, electromagnetic, optical or other signals capable of being received by communications interface 924. These signals 928 are provided to communications interface 924 via a communications path (e.g., channel) 926. This path 926 carries signals 928 and may be implemented using wire or cable, fiber optics, a telephone line, a cellular link, a radio frequency (RF) link and/or other communications channels. In this document, the terms “computer program medium” and “computer usable medium” are used to refer generally to media such as a removable storage drive 980, a hard disk installed in hard disk drive 970, and signals 928. These computer program products provide software to the computer system 900. Aspects of the invention are directed to such computer program products.

Computer programs (also referred to as computer control logic) are stored in main memory 908 and/or secondary memory 910. Computer programs may also be received via communications interface 924. Such computer programs, when executed, enable the computer system 900 to perform the features of the present invention, as discussed herein. In particular, the computer programs, when executed, enable the processor 910 to perform various features in accordance with aspects of the present invention. Accordingly, such computer programs represent controllers of the computer system 900.

In a variation where various aspects of the invention are implemented using software, the software may be stored in a computer program product and loaded into computer system 900 using removable storage drive 914, hard drive 912, or communications interface 920. The control logic (software), when executed by the processor 904, causes the processor 904 to perform the functions of the invention as described herein. In another variation, various aspects of the invention are implemented primarily in hardware using, for example, hardware components, such as application specific integrated circuits (ASICs). Implementation of the hardware state machine so as to perform the functions described herein will be apparent to persons skilled in the relevant art(s).

In yet another aspect, the invention is implemented using a combination of both hardware and software.

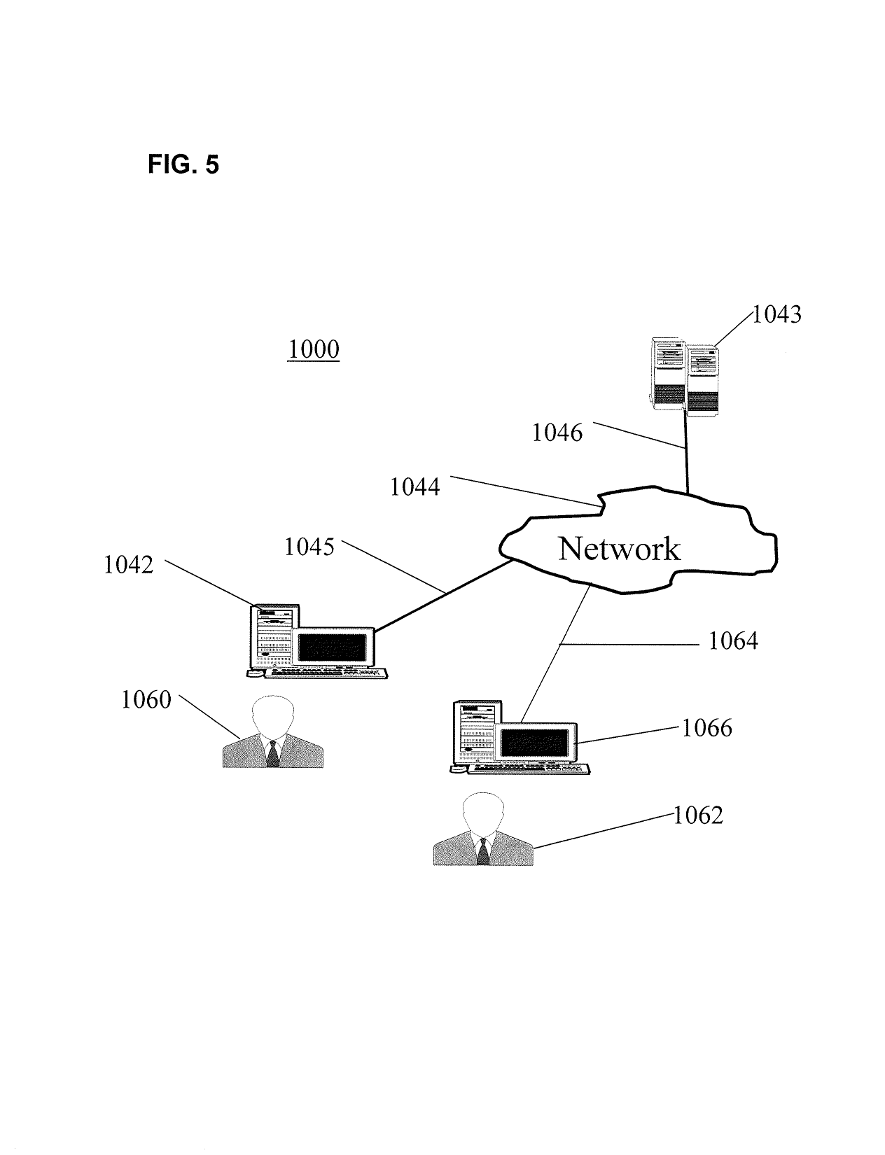

FIG. 5 is a block diagram of various example system components, in accordance with an aspect of the present invention. FIG. 5 shows a communication system 1000 usable in accordance with the present invention. The communication system 1000 includes one or more accessors 1060, 1062 (also referred to interchangeably herein as one or more “users”) and one or more terminals 1042, 1066. In one aspect, data for use in accordance with the present invention is, for example, input and/or accessed by accessors 1060, 1062 via terminals 1042, 1066, such as personal computers (PCs), minicomputers, mainframe computers, microcomputers, telephonic devices, or wireless devices, such as personal digital assistants (“PDAs”) or a hand-held wireless devices coupled to a server 1043, such as a PC, minicomputer, mainframe computer, microcomputer, or other device having a processor and a repository for data and/or connection to a repository for data, via, for example, a network 1044, such as the Internet or an intranet, and couplings 1045, 1046, 1064. The couplings 1045, 1046, 1064 include, for example, wired, wireless, or fiberoptic links. In another variation, the method and system in accordance with aspects of the present invention operate in a stand-alone environment, such as on a single terminal.

While aspects of this invention have been described in conjunction with the example features outlined above, various alternatives, modifications, variations, improvements, and/or substantial equivalents, whether known or that are or may be presently unforeseen, may become apparent to those having at least ordinary skill in the art. Accordingly, the example aspects of the invention, as set forth above, are intended to be illustrative, not limiting. Various changes may be made without departing from the spirit and thereof. Therefore, aspects of the invention are intended to embrace all known or later-developed alternatives, modifications, variations, improvements, and/or substantial equivalents.

What is claimed is:

1. A method of finding a desired contact in a contacts directory of a smart device comprising:
providing a plurality of contacts in the contacts directory;
creating a group of fields for at least one of the contacts, the group of fields comprising a plurality of fields;
providing a search engine to the smart device;
entering one or more search terms in the smart device; and
retrieving one or more contacts based on the entered one or more search terms;
wherein each group of fields comprises at least one field in addition to a first name field, a last name field and a company name field.

2. The method of claim 1, wherein for each contact, the fields within each group of fields share a common label that is specific to the contact.

3. The method of claim 1, wherein the fields comprise at least one of a first name, a last name, a company name, an email address, a telephone number, an area code, a nickname, an address, and a zip code.

4. The method of claim 1, wherein retrieving one or more contacts includes displaying the one or more contacts on a screen of the smart device.

5. The method of claim 1, wherein the desired contact is one of the retrieved one or more contacts.

6. A system for finding a desired contact in a contacts directory of a smart device, the system comprising:
a processor;
a user interface functioning via input from the processor; and
a repository accessible by the processor; wherein:
a plurality of contacts is provided in the contacts directory;
a group of fields is created for at least one of the contacts, the group of fields comprising a plurality of fields;
a search engine is provided to the smart device;
one or more search terms are entered in the smart device;
one or more contacts are retrieved based on the entered one or more search terms; and
each group of fields comprises at least one field in addition to a first name field, a last name field and a company name field.

7. The system of claim 6, wherein for each contact, the fields within each group of fields share a common label that is specific to the contact.

8. The system of claim 6, wherein the fields comprise at least one of a first name, a last name, a company name, an email address, a telephone number, an area code, a nickname, an address, and a zip code.

9. The system of claim 6, wherein the retrieved one or more contacts are displayed on a screen of the smart device.

10. The system of claim 6, wherein the desired contact is one of the retrieved one or more contacts.

11. The system of claim 6, wherein the processor is housed on a terminal selected from a group consisting of a personal computer, a minicomputer, a main frame computer, a microcomputer, a hand held device, and a telephonic device.

12. The system of claim 6, wherein the processor is housed on a server selected from a group consisting of a personal computer, a minicomputer, a microcomputer, and a main frame computer.

13. The system of claim 12, wherein the server is coupled to a network via a coupling selected from a group consisting of a wired connection, a wireless connection, and a fiberoptic connection.

14. A system for finding a desired contact in a contacts directory of a smart device, the system comprising:
means for providing a plurality of contacts in the contacts directory;
means for creating a group of fields for at least one of the contacts, the group of fields comprising a plurality of fields;
means for providing a search engine to the smart device;
means for entering one or more search terms in the smart device; and
means for retrieving one or more contacts based on the entered one or more search terms;
wherein each group of fields comprises at least one field in addition to a first name field, a last name field and a company name field.

15. A computer program product comprising a non-transitory computer usable medium having control logic stored therein for causing a computer to find a desired contact in a contacts directory of a smart device, the control logic comprising:
computer readable program code means for providing a plurality of contacts in the contacts directory;
computer readable program code means for creating a group of fields for at least one of the contacts, the group of fields comprising a plurality of fields; computer readable program code means for providing a search engine to the smart device;
computer readable program code means for entering one or more search terms in the smart device; and
computer readable program code means for retrieving one or more contacts based on the entered one or more search terms;
wherein each group of fields comprises at least one field in addition to a first name field, a last name field and a company name field.
